(19) United States
(12) Patent Application Publication
(10) Pub. No.: US 2012/0096435 A1
(43) Pub. Date: Apr. 19, 2012

(54) CAPABILITY-BASED APPLICATION RECOMMENDATION

(75) Inventors: Dragos Manolescu, Kirkland, WA (US); Henricus Johannes Maria Meijer, Mercer Island, WA (US)

(73) Assignee: MICROSOFT CORPORATION, Redmond, WA (US)

(21) Appl. No.: 12/906,364

(22) Filed: Oct. 18, 2010

(51) Int. Cl. G06F 9/44

(52) U.S. Cl. 717/121

(57) ABSTRACT

Capabilities associated with a capability-based security model are utilized as a basis for discriminating between software applications. More specifically, software applications can be identified as a function of capabilities. A comparison can be made between software application capabilities and capabilities of interest to identify matches. Subsequently, users can be notified of any matching software applications.

### BACKGROUND

Users of online stores can benefit from guidance when browsing for and eventually purchasing goods or services. To that end, conventional online retailers (e.g., Amazon®, Netflix® . . . ) rely on recommendation technologies. These technologies make recommendations, or in other words suggestions, based on a user profile that specifies demographic information (e.g., age, gender, location . . . ). To improve recommendations, past purchase history and user-contributed ratings can also be exploited.

One particular type of online store is an application store, which is rapidly becoming the preferred manner of distributing software and more particularly third-party software. Here, users can acquire software applications for their computers or computing devices including mobile phones and personal digital assistance, among others, from the store. Accordingly, users can benefit from guidance with respect to exploring and locating applications. Similar to other goods and services, a user profile, past purchase history, and ratings of others have been employed to aid provisioning of recommendations. Additionally, one conventional technology filters applications based on compatibility of an application with hardware and/or software of a user device. For example, if an application requires geographical location hardware (e.g., Global Positioning System (GPS) receiver) and the device does not include such hardware then the application will be filtered out or removed from a set of one or more recommended applications. On the other hand, if the device does include such hardware, the application can be recommended.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to capability-based application recommendation. One or more capabilities associated with a capability-based security model can be utilized as a basis for discriminating between software applications. More particularly, software applications can be recommended to users as function of application capabilities. In one embodiment, a comparison can be made between application capabilities and preferences specified in terms of capabilities in an attempt to identify a match. Subsequently, users can be notified of one or more software applications that satisfy their preferences and consequently respect the users' privacy and/or security tolerances.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a recommendation system.

FIG. 2 is a block diagram of a representative data-acquisition component.

FIG. 3 is a block diagram of a system that facilitates application provisioning.

FIG. 4A is a block diagram of a recommendation system architecture.

FIG. 4B is a block diagram of a recommendation system architecture.

FIG. 5 is a block diagram of an application management system.

FIG. 6 is a flow chart diagram of a method of application recommendation.

FIG. 7 is a flow chart diagram of a method of application recommendation.

FIG. 8 is a flow chart diagram of a method of application recommendation.

FIG. 9 is a flow chart diagram of a method of application management.

FIG. 10 is a schematic block diagram illustrating a suitable operating environment for aspects of the subject disclosure.

### DETAILED DESCRIPTION

Details below are generally directed toward capability-based application recommendation. A capability refers to a security concept rather than a general quality of being capable or able, for example, to do something. More specifically, a capability is a token of authority that references an object and includes access rights associated with the object.

Software is more complex than downloadable music, books, and most other types of merchandise that is typically purchased online (e.g., across a network). In particular, software applications are becoming increasingly powerful and complex. For example, a software application could disclose private information, access device sensors (GPS, microphone . . . ), and/or communicate with network, or cloud-based, services, among other things. As a result, privacy and security concerns can be a significant factor when selecting an application.

As provided herein, capabilities can be utilized as a basis for discriminating between software applications and more particularly for software application recommendation. Although not limited thereto, user preferences captured in terms of capabilities can be utilized to identify applications of interest in one instance. A comparison can be made between application capabilities and capabilities of interest in an attempt to identify a match. Subsequently, a user can be notified of one or more matching software applications. In one particular embodiment, if a software application is added to an application store that has capabilities matching a user's preferences, that user can be notified of the software application. In any event, the subject recommendation model provides software application recommendation as a function of privacy and/or security concerns.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

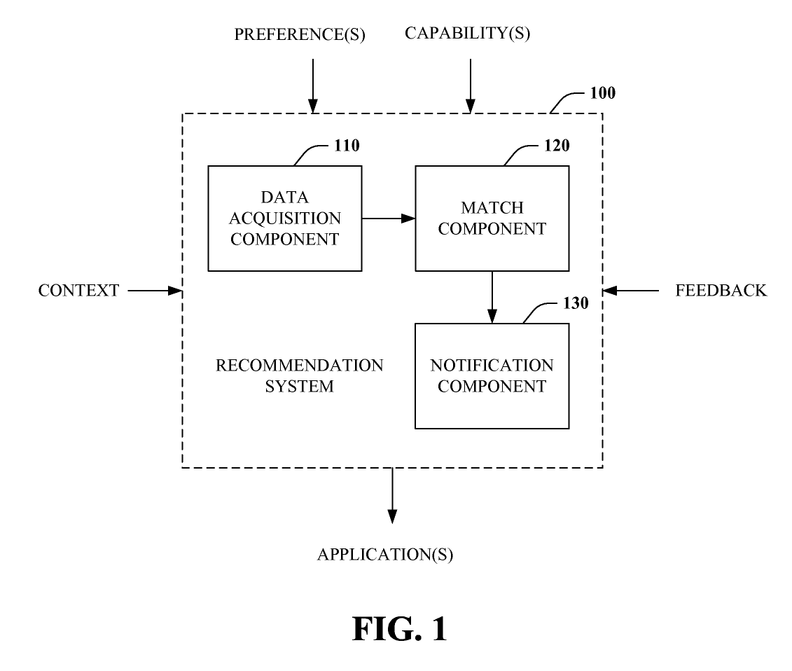

Referring initially to FIG. 1, a recommendation system 100 is illustrated that provides guidance with respect to browsing and potentially acquiring software applications. More specifically, the recommendation system 100 can recommend, or in other words suggest, one or more applications to users based on at least one of a number of factors. In accordance with one aspect of the claimed subject matter, the recommendation system 100 can exploit capabilities to discriminate between applications.

A capability, as used herein, is intended to refer to a security concept in a capability-based security model rather than a general quality of being capable or able, for example to do something. More specifically, a capability is a token of authority that references an object and includes a set access rights associated with the object. An object is any entity (e.g., hardware and/or software) that can be manipulated by instructions of a computer programming language (e.g., data structure, program construct, sensors . . . ). Access rights identify allowable and/or impermissible operations over an object. By way of example and not limitation, a capability can reference geographical location hardware (e.g., GPS) and specify that access be allowed. In other words, for an application to function as intended, access needs to be granted to the geographical location hardware. Note that whether a computer or other processor-based device includes such hardware is a first-level concern. A second-level concern is whether access to the available hardware is allowed. Other examples of capabilities include access to other sensors (e.g., microphone, gyroscope, thermometer . . . ), access to particular data (e.g., contacts, user names and passcodes, access to a particular communication protocol (e.g., Wi-Fi, 3G, CDMA . . . ), access to network data or a network service, storage of particular data locally or remotely, etc.

The recommendation system 100 includes a data acquisition component 110 that is generally configured to receive, retrieve, or otherwise obtain or acquire data or information that is useful in formulating application recommendations (e.g., for or against particular applications). As show in FIG. 1, the recommendation system 100 can acquire one or more preferences, one or more capabilities, and/or context information, among other things.

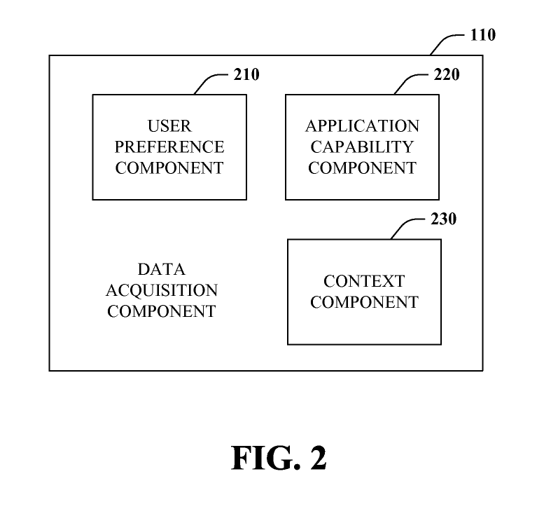

Turning briefly to FIG. 2, a representative data-acquisition component 110 is shown in further detail. As illustrated, the data acquisition component 110 includes a user preference component 210, an application capability component 220, and a context component 230. The user preference component 210 is configured to acquire preferences associated with a person or entity that can utilize an application in terms of one or more capabilities. For example, a preference can indicate whether access to an address book or contacts in permissible or impermissible. Additionally, preferences can be specified in terms of combinations of capabilities. For instance, access to both personal information and communication hardware is not permitted, since information might be leaked, but access with respect to only one of personal information or communication hardware is allowed. Further, preference acquisition can be explicit or implicit. For example, the user preference component 210 can be configured to receive specification of preferences in terms of capabilities from a user or ask the user questions to determine the preferences from responses. Furthermore, the user preference component 210 can infer preferences, for example from applications installed on a user's computer. Still further yet, preferences can be static, but the preferences can also be context dependent. Accordingly, preferences or capabilities can vary when a user is at home versus at work, for example.

The application capability component 220 is configured to receive, retrieve, or otherwise obtain or acquire one or more capabilities associated with an application. In accordance with one embodiment, an application can include or be associated with a manifest, which can be a file (e.g., XML (eXtensible Markup Language), that provides information to facilitate execution of an application including capabilities. Accordingly, the application capability component 220 can locate and acquire application capabilities from the manifest. In this manner, such information can be repurposed and exploited for recommendations. Of course, the application capability component 220 could also analyze and determine or infer capabilities from an application itself alone or in combination with other information. For example, the application capability component 220 could locate software reviews and other comments regarding the application posted on the webpage or social network and infer capabilities from such information.

The context component 230 is configured to receive, retrieve or otherwise obtain or acquire context or context information for subsequent use to facilitate recommendations. As previously mentioned, user preferences can be context sensitive. Accordingly, the context component 230 can provide information to aid specification and interpretation of user preferences. By way of example and not limitation, the context component 230 can provide location information so that preferences can be specified and interpreted with respect to whether a user is at home or at work utilizing calendar information, Internet service provider (ISP), and/or a global positioning system (GPS), among other things.

Returning to FIG. 1, the match component 120 can utilized information provided at least from the data acquisition component 110 to identify applications that satisfy user preferences. More specifically, the match component 120 can compare one or more capabilities of an application with one or more capabilities specified as preferences and determine when one or more capabilities match. An overall match between a user and an application can be said to occur when a set number of capabilities are common to both the preferences and the application. Furthermore, in accordance with one embodiment, a known or novel similarity search (a.k.a., nearest neighbor search or proximity search) algorithm can be utilized to facilitate identification of applications that interest users. Here, a score can be produced indicative of a degree of similarity or dissimilarity between preferences and application capabilities, and a match be defined by a range or threshold degree of similarity or dissimilarity. In other words, a match need not be an exact match but rather can be a correlation of some degree.

The notification component 130 is communicatively coupled to the match component 120 and configured to notify a user upon a determination that a match has occurred. More specifically, information regarding an application can be provided to a user. For example, a notification can indicate the following: “Because you are interested in applications that integrate with your contacts, applications X and Y are recommended.” Notifications can be provisioned in a variety of ways. For instance, a computer can show a notification similar to the manner in which a user is notified that software updates are available. Furthermore, a text or e-mail can be sent, among other things. In any event, notification component 130 seeks to notify a user that one or more applications of interest to the user are available.

Additionally, feedback concerning relevance can be employed to refine matches. This is particularly useful with where a similarity search or the like is employed. Unlike an exact search (e.g., select employee where id=100) where the query is precisely articulated, in similarity search relevance feedback allows the user to iterate and make small corrections to the query until the results are satisfactory. For example, a user can mark suggested applications with an indication of relevance that can be used to refine suggestions.

Note that the recommendation system 100 does not require user preferences to operate. In one instance, a user might be lazy and not provide preferences, or the user may not want to reveal any preferences. Additionally, the user might not know device capabilities and thus would not be able to specify preferences. Broadly, the recommendation system 100 can identify an application based on capabilities and optionally as a function of context information excluding user preferences. For example, context information that a threshold number of users (e.g., ninety percent) purchased or liked a certain application can be utilized to include or exclude applications.

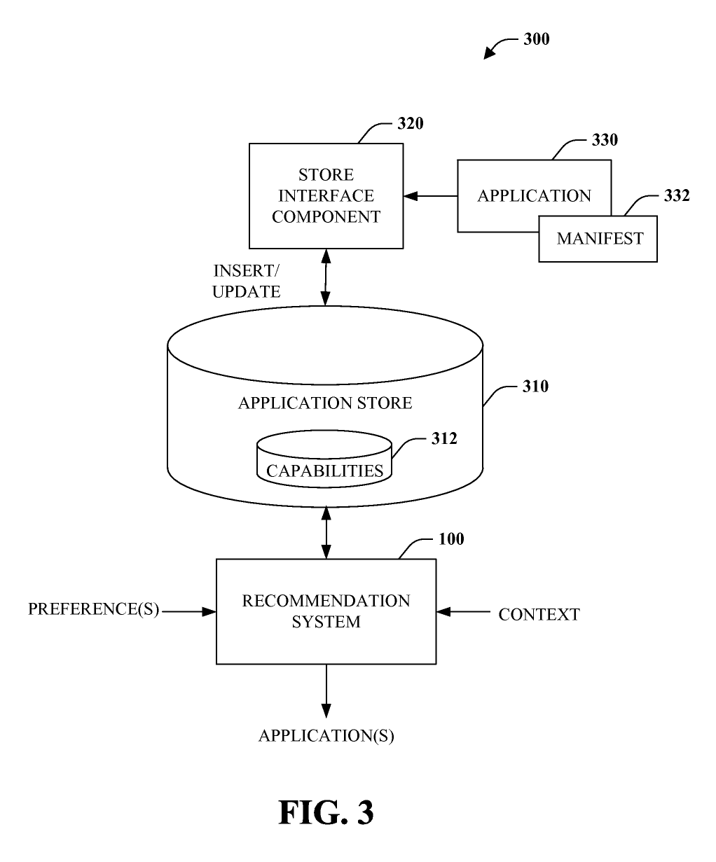

Turning attention to FIG. 3 a system 300 is illustrated that facilitates application provisioning. The system 300 includes an application store 310 that stores software applications and capabilities, among other things, for subsequent querying or exploration. The system 300 also includes a store interface component 320 that is configured to insert and update applications with respect to the application store 310. Furthermore, the system 300 includes the recommendation system 100, as previously described with respect to FIG. 1, to recommend or in other words suggest applications as a function of one or more preferences, capabilities, and optionally context.

As mentioned, the store interface component 320 provides a means for inserting and updating application store data. For example, a software developer can utilize the store interface component 320 to submit an application 330 to the application store 310 or update an existing application in the application store 310. Furthermore, the application 330 can include or be associated with a manifest 332 that includes, among other things, capabilities the application 330 needs to provide its full functionality (e.g., access to location hardware, access to contacts . . . ). For instance, the manifest 332 can be an XML file or other form that specifies the syntax and semantics of one or more capabilities. Upon acquisition of the application 330 and manifest 332, the store interface component 320 can perform some preliminary checks, for instance to ensure the application 330 utilizes the capabilities, and then stores the application in the application store 310. Moreover, the store interface component 320 can store capabilities acquired from the manifest 332 in a capabilities store 312 to facilitate subsequent interaction and recommendation. Similar functionality is enabled with respect to updating an existing application in the application store 310. In particular, if capabilities are added or removed as a function of the update then the store interface component 320 can update the capabilities store 312 to reflect the changes.

The recommendation system 100 operates as previously described. Briefly, the recommendation system 100 can acquire preferences specified in terms of one or more capabilities from users some of which may be context dependent. Subsequently, the recommendation system 100 can search the capabilities store 312 for capabilities that match those related to a user and notify the user of such matching applications. The user can then interact with the store and download one or more matching application to a computer for free or for a fee, if desired.

In accordance with one embodiment, application store can be monitored and action by the recommendation system 100 can be triggered upon insertion of an application 330 into the application store 310 or an update to an existing application in the application store 310 by the store interface component 320. For example, upon insertion of an application 330 into the application store 310 and addition of the applications capabilities to the capability store 312, the recommendation system 100 can be triggered to identify matches between the newly added application's capabilities and capabilities specified by one or more users as preferences. If the new application with capabilities that match or otherwise satisfy a user's preferences is added to the application store 310, the recommendation system 100 can notify the user about the availability of the application, thus allowing the user to explore the new content. Similarly, if an existing application update modifies application capabilities, users with matching preferences can be notified. In other words, the system 300 can operate in accordance with a push-based model wherein users are notified by the recommendation system 100 upon addition of an application to the application store 310, for example, that matches their preferences.

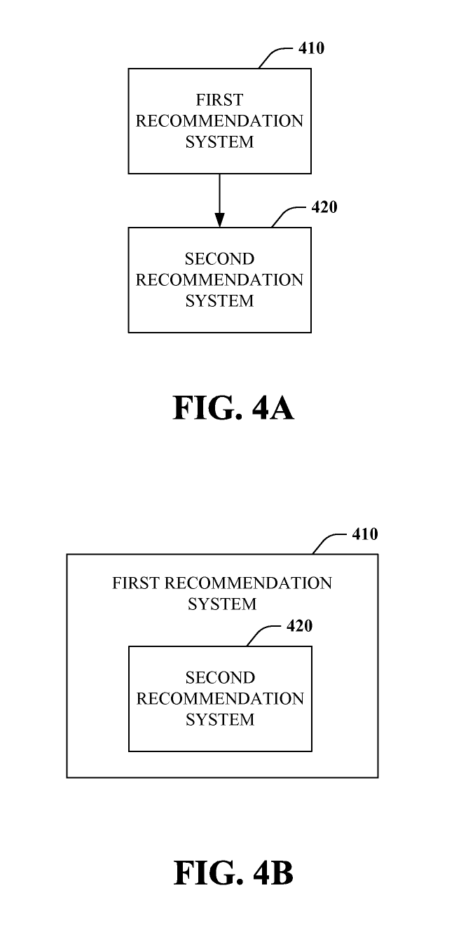

The functionality of the recommendation system 100 of FIG. 1 can be embodied in a single recommendation system as previously described. However, the claimed subject matter is not limited thereto. In particular, the general functionality of making a recommendation as a function of capabilities can be embodied in a number of different manners or architectures, two of which are illustrated in FIGS. 4A-B.

Turning attention to FIG. 4A a recommendation architecture is depicted including two recommendation systems, namely first recommendation system 410 and second recommendation system 420. In accordance with one embodiment, the first recommendation system 410 can provide recommendations of applications based on such factors typically associated with other online goods and/or services such as but not limited to user demographic information, past purchase history and/or user contributed ratings. The second recommendation system 420 can take recommendations from the first recommendation and refine the recommendations by identifying applications with capabilities that match user preferences. The resulting recommendation is the union of functionality provided by the first recommendation system 410 and the second recommendation system 420. Furthermore, it should be appreciated that the reverse configuration is also possible wherein the first recommendation system 410 provides recommendations as a function of capabilities while the second recommendation system 420 refines recommendations based on other factors including but not limited to user demographic information and past purchase history.

FIG. 4B illustrates another recommendation architecture including the first recommendation system 410 and the second recommendation system 420. Here functionality of the second recommendation system can be embedded within the first recommendation system 410. In one embodiment, the second recommendation system 420 can correspond to a system that makes recommendations based on capabilities while the first recommendation system 410 makes recommendations based on other factors such as those typically associated with online goods and/or services, among others. By embedding the second recommendation system 420, recommendation computation scores can reflect capability matches. In other words, the first recommendation system can be augmented to factor in capability matches in recommendations. The reverse can also be true. For example, the first recommendation system 410 can correspond to a system that makes recommendations based on capabilities, which can be augmented by embedding functionality associated with a second component that makes recommendations based on other factors.

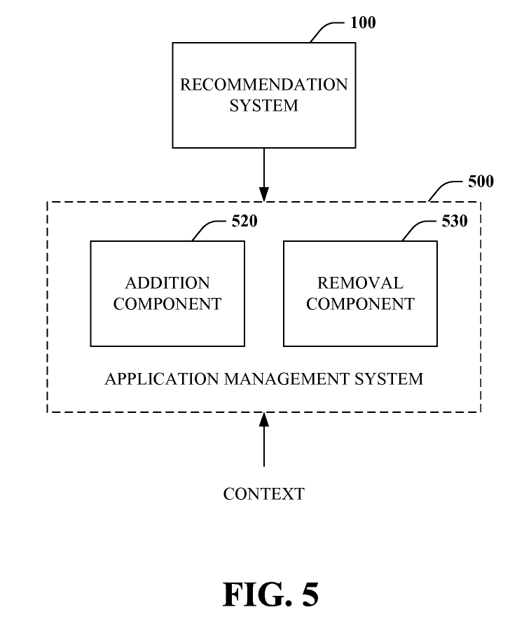

Referring to FIG. 5 an application management system 500 is illustrated. The application management system can reside on a processor-based device or provided as a service (e.g., Web/Cloud service). More particularly, the application management system can interact with the recommendation system 100, as previously described, and manage applications with respect to a particular machine.

As shown, the application management system 500 can include an addition component 520 and a removal component 530. The addition component 520 is configured to facilitate addition of software applications recommended by the recommendation system 100. For example, the addition component 520 can be configured to automatically download and install applications suggested by the recommendation system 100 as a function of capabilities. By contrast, the removal component 530 can be configured to remove applications from a machine. Further, the recommendation system 100 is capable of recommending applications that a user would not be interested in based on preferences specified in terms of capabilities. Accordingly, if such “un-recommended” applications reside on a machine, the removal component 530 can remove the applications, for example, via uninstallation. Additionally or alternatively, addition component 520 and removal component 530 can be configured to activate and deactivate software, respectively.

As previously mentioned, capabilities need not be static but rather can be context dependent. Accordingly, whether an application satisfies user preferences can change based on the context. Consider, for instance, the contexts of home versus work. Preferences, and thus capabilities, can be different in those contexts. For example, a particular capability can be permitted at home but prohibited at work such as the accessing a particular web service. Accordingly, when a user is at home the addition component 520 can activate such software and when at work the removal component 530 can deactivate. Of course, the software application could be uninstalled and reinstalled, but that is much more work than activation and deactivation. As another example, when traveling certain applications and/or functionality associated with an application can be deemed legal or illegal. As a result, if a user travels to a country where an application is illegal, the removal component 530 can deactivate or uninstall the applications. If the user travels to another country where the software is legal again, the addition component 520 can activate or reinstall the application.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the recommendation system 100 can utilize such functionality to infer preferences for example from currently installed applications, among other things, and/or infer capability matches.

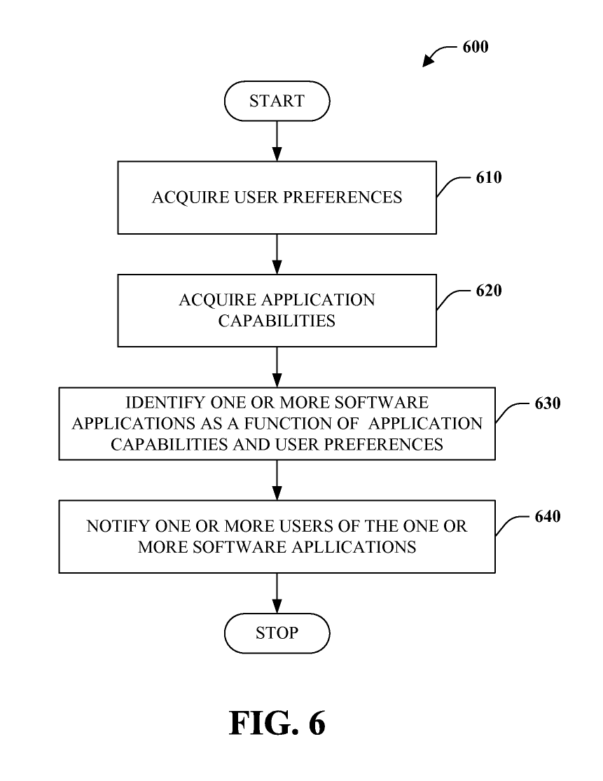

In view of the exemplary systems described supra, methodologies that may be implemented in accordance with the disclosed subject matter will be better appreciated with reference to the flow charts of FIGS. 6-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 6, a method of application recommendation 600 is depicted. At reference numeral 610, user preferences can be acquired. Here, user preferences can be specified in terms of capabilities. In one instance, a user can explicitly specify preferences. In this manner, a user can specifically articulate what device resources, for example, the user is comfortable allowing applications to access. Alternatively, such preferences can be inferred from context including such things as currently installed applications. For example, if a user has applications that interact with contacts, it can be inferred that the user has a preference for applications with a capability that allows interaction with contacts.

At numeral 620, application capabilities can be acquired. Such capabilities identify what object(s) an application needs permission to access to enable the application to perform its full functionality. In accordance with one embodiment, the capabilities can be located and retrieved from a manifest associated with an application. Typically, a manifest is provided to facilitate installation and execution, among other things. Furthermore, capabilities associated with a capability-bases security model can be included in the manifest. Alternatively, capabilities can be determined or inferred based on an analysis of an application.

At reference numeral 630, one or more software applications can be identified as a function of application capabilities and user preferences. More specifically, a comparison can be made between application capabilities and users preferences specified in terms of capabilities. Where one or more capabilities of an application match one or more user preferences, or are someway correlated within a predetermined threshold, a match can be deemed to have occurred. In accordance with one embodiment, a similarity search can be performed to identify software applications “matching” user preferences.

At numeral 640, one or more users can be notified of one or more software applications. More particularly, users are notified or otherwise informed of software applications that satisfy their preferences with respect to one or more capabilities. Such notification can be by e-mail, text message, or any other communication medium. In accordance with one embodiment, such notification can occur in a manner similar to conventional notification regarding software updates, for example, where a bubble is displayed with respect to a toolbar icon. These notifications, however, can inform a user that new or updated software is available with capabilities of interest.

Although not shown, it is to be appreciated that the method of application recommendation 600 need not employ user preferences as matching criteria. Alternatively, context information can be employed. For example, one or more software applications can be identified as a function of capabilities and purchases of the software application, application ratings, or other context information. In this manner, recommendations can be made when user preferences are not available, for instance when a user does not desire to provide such information. Of course, such context information can also be combined with available preferences to provide a more fine grained or precise suggestion.

Furthermore, relevance feedback can be employed to refine application recommendation. For example, initial results can be marked with a relevance score or like indication of relevance. Subsequently, the act of identifying one or more software applications at 630 can be re-run to take the relevance feedback into account. Subsequently, users can be notified of a refined result set of applications at 640 and the process can continue until results are satisfactory to a user.

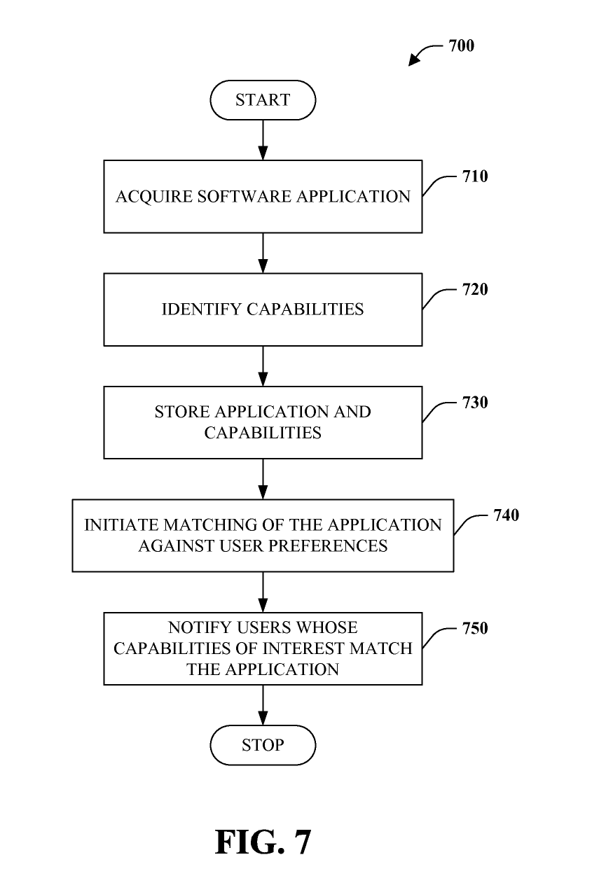

FIG. 7 illustrates a method of application recommendation 700. At reference numeral 710, a software application is received, retrieved or otherwise obtained or acquired. For example, a developer could have submitted a software application to be added to an application store. At numeral 720, capabilities associated with the application can be identified, for example from a manifest associated with the application. At 730, the acquired application and identified capabilities are stored or saved to a non-volatile computer-readable medium. At reference numeral 740, matching is initiated of the application's one or more capabilities and user preferences. For example, matching can be initiated in response to detection of a change to the store as a result of monitoring the store. In other words, a comparison is initiated in an attempt to identify users that would be interested in the applications based on their preferences specified in terms of one or more capabilities. At reference numeral 750, users whose capabilities of interest match or otherwise correlate within a degree or threshold are notified of the addition of the application.

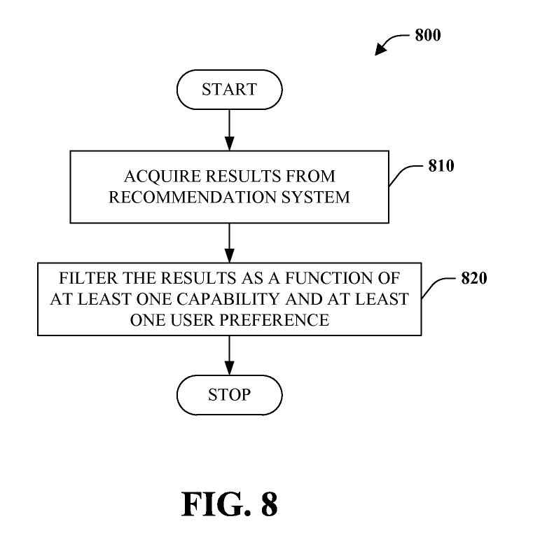

FIG. 8 is a flow chart diagram depicting a method 800 of application recommendation in accordance with a particular architecture. At reference numeral 810, results are acquired from a recommendation system that makes recommendations based on such factors as a user's profile, demographic information, past purchase history and user-contributed ratings. At numeral 820, the results of the recommendation system are filtered or otherwise refined as a function of at least one capability and at least one user preference relating to capabilities. In this manner, method 800 illustrates one manner of employing capability-based recommendations in conjunction with recommendations that make suggestions based on other factors.

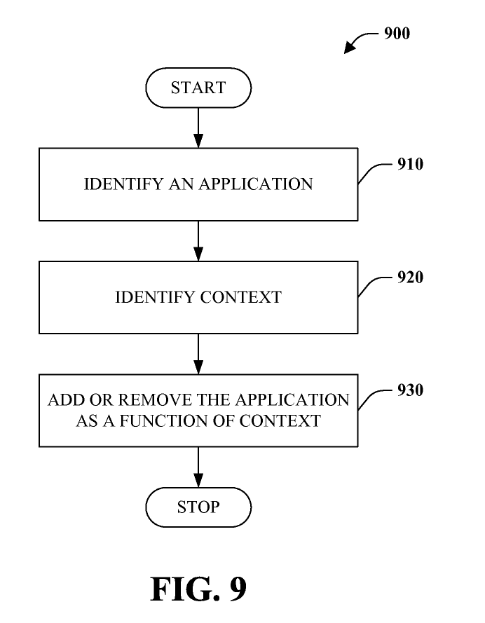

FIG. 9 illustrates a method of application management 900. At reference numeral 910, a software application is identified. For example, such an application can be identified based on capabilities of the application and user preferences. At numeral 920, context or context information is identified. In particular, the context can related to user preferences specified in terms of capabilities. At reference numeral 930, the identified software application is added or removed from a computer or other processor-based device as a function of the context. In other words, interest in an application with particular capabilities can depend on context. Accordingly, an application can be installed/uninstalled, activated/deactivated based on current context.

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

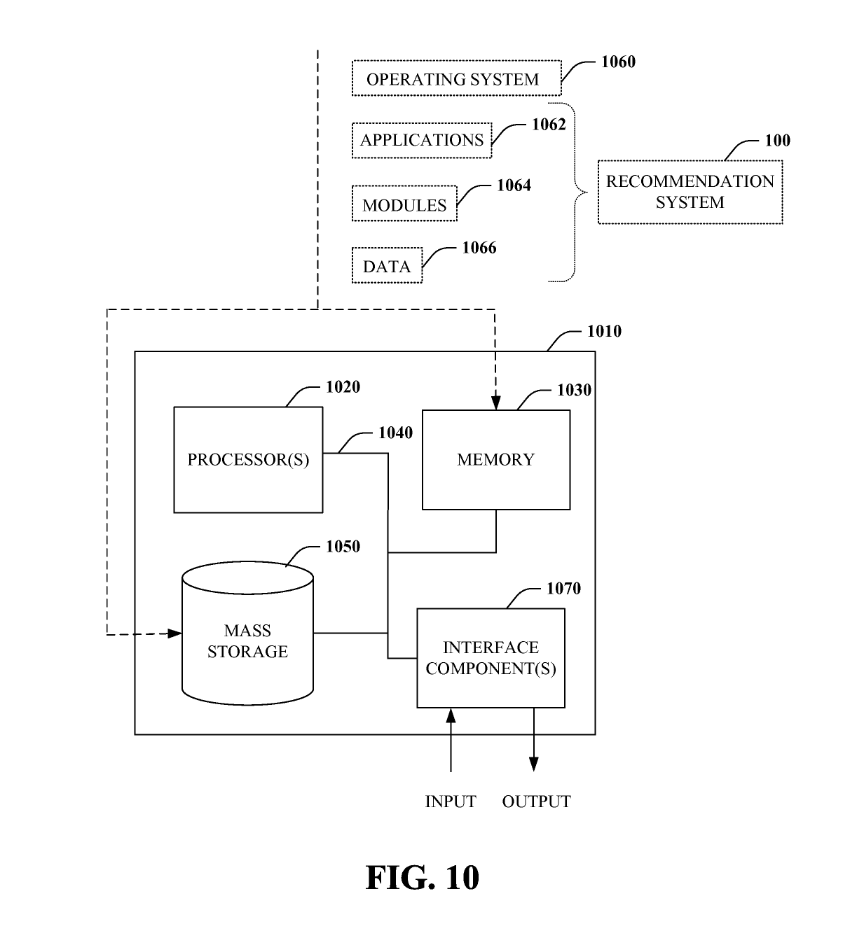

In order to provide a context for the claimed subject matter, FIG. 10 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 10, illustrated is an example general-purpose computer 1010 or computing device (e.g., desktop, laptop, server, hand-held, programmable consumer or industrial electronics, set-top box, game system . . . ). The computer 1010 includes one or more processor(s) 1020, memory 1030, system bus 1040, mass storage 1050, and one or more interface components 1070. The system bus 1040 communicatively couples at least the above system components. However, it is to be appreciated that in its simplest form the computer 1010 can include one or more processors 1020 coupled to memory 1030 that execute various computer executable actions, instructions, and or components stored in memory 1030.

The processor(s) 1020 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1020 may also be implemented as a combination of computing devices, for example a combination of a DSP and a microprocessor, a plurality of microprocessors, multi-core processors, one or more microprocessors in conjunction with a DSP core, or any other such configuration.

The computer 1010 can include or otherwise interact with a variety of computer-readable media to facilitate control of the computer 1010 to implement one or more aspects of the claimed subject matter. The computer-readable media can be any available media that can be accessed by the computer 1010 and includes volatile and nonvolatile media and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 1010.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1030 and mass storage 1050 are examples of computer-readable storage media. Depending on the exact configuration and type of computing device, memory 1030 may be volatile (e.g., RAM), non-volatile (e.g., ROM, flash memory . . . ) or some combination of the two. By way of example, the basic input/output system (BIOS), including basic routines to transfer information between elements within the computer 1010, such as during start-up, can be stored in nonvolatile memory, while volatile memory can act as external cache memory to facilitate processing by the processor(s) 1020, among other things.

Mass storage 1050 includes removable/non-removable, volatile/non-volatile computer storage media for storage of large amounts of data relative to the memory 1030. For example, mass storage 1050 includes, but is not limited to, one or more devices such as a magnetic or optical disk drive, floppy disk drive, flash memory, solid-state drive, or memory stick.

Memory 1030 and mass storage 1050 can include, or have stored therein, operating system 1060, one or more applications 1062, one or more program modules 1064, and data 1066. The operating system 1060 acts to control and allocate resources of the computer 1010. Applications 1062 include one or both of system and application software and can exploit management of resources by the operating system 1060 through program modules 1064 and data 1066 stored in memory 1030 and/or mass storage 1050 to perform one or more actions. Accordingly, applications 1062 can turn a general-purpose computer 1010 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the recommendation system 100 can be, or form part, of an application 1062, and include one or more modules 1064 and data 1066 stored in memory and/or mass storage 1050 whose functionality can be realized when executed by one or more processor(s) 1020.

In accordance with one particular embodiment, the processor(s) 1020 can correspond to a system on a chip (SOC) or like architecture including, or in other words integrating, both hardware and software on a single integrated circuit substrate. Here, the processor(s) 1020 can include one or more processors as well as memory at least similar to processor(s) 1020 and memory 1030, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the recommendation system 100 or associated functionality can be embedded within hardware in a SOC architecture.

The computer 1010 also includes one or more interface components 1070 that are communicatively coupled to the system bus 1040 and facilitate interaction with the computer 1010. By way of example, the interface component 1070 can be a port (e.g., serial, parallel, PCMCIA, USB, FireWire . . . ) or an interface card (e.g., sound, video . . . ) or the like. In one example implementation, the interface component 1070 can be embodied as a user input/output interface to enable a user to enter commands and information into the computer 1010 through one or more input devices (e.g., pointing device such as a mouse, trackball, stylus, touch pad, keyboard, microphone, joystick, game pad, satellite dish, scanner, camera, other computer . . . ). In another example implementation, the interface component 1070 can be embodied as an output peripheral interface to supply output to displays (e.g., CRT, LCD, plasma . . . ), speakers, printers, and/or other computers, among other things. Still further yet, the interface component 1070 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method, comprising:
employing at least one processor configured to execute computer-executable instructions stored in memory to perform the following acts:
identifying one or more software applications as a function of at least one application capability.

2. The method of claim 1 further comprises identifying the one or more applications as a function of at least one user preference.

3. The method of claim 2 further comprises inferring the at least one user preference based on context.

4. The method of claim 2 comprises executing a similarity search to identify the one or more software applications.

5. The method of claim 4 further refining results of the similarity search as a function of relevance feedback.

6. The method of claim 1 further comprises generating a notification that identifies the one or more software applications.

7. The method of claim 1 further comprises filtering results from a recommendation system based on the one or more software applications identified.

8. The method of claim 1 further comprises disabling at least one of the one or more software applications.

9. The method of claim 1 further comprises monitoring a store for newly added applications.

10. A system to facilitate identification of software applications, comprising:
a processor coupled to a memory, the processor configured to execute the following computer-executable components stored in the memory:
a match component configured to identify at least one software application whose one or more capabilities match one or more capabilities of interest.

11. The system of claim 10, the one or more capabilities of the at least one software application are saved in an application store.

12. The system of claim 10, the match component is configured to initiate identification of the at least one software application when a software application is added to an application store.

13. The system of claim 10, the match component is configured to identify the at least one software application as a function of context.

14. The system of claim 10, the match component is configured to employ a similarity search to identify the one or more software applications.

15. The system of claim 10 further comprises a notification component configured to notify one or more users of the one or more software applications whose capabilities match capabilities of interest of the one or more users.

16. The system of claim 10 further comprising an addition component configured to aid addition of the at least one software application to a machine.

17. The system of claim 10 further comprising a removal component configured to aid removal of the at least one software application from a machine.

18. A computer-readable medium having instructions stored thereon that enables at least one processor to perform the following acts:
comparing one or more capabilities of a software application with one or more capabilities of interest to a user, wherein a capability identifies an object and one or more operations allowed with respect to the object; and
notifying the user regarding the software application if a match exists between at least one of the one or more capabilities of the software application and the one or more capabilities of interest to the user.

19. The computer-readable medium of claim 18 further comprising initiating the act of comparing when an application is added to a store.

20. The computer-readable medium of claim 18 further comprising initiating the act of comparing when an application is updated on a store.
